(19) United States
(12) Patent Application Publication
(10) Pub. No.: US 2010/0284868 A1
(43) Pub. Date: Nov. 11, 2010

(54) CATALYTIC COMBUSTOR AND FUEL REFORMER HAVING THE SAME

(75) Inventors: In-Hyuk SON, Suwon-si (KR); Woo-Cheol SHIN, Suwon-si (KR); Jin-Goo AHN, Suwon-si (KR); Jong-Rock CHOI, Suwon-si (KR); Sung-Chul LEE, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Suwon-si (KR)

(21) Appl. No.: 12/621,317

(22) Filed: Nov. 18, 2009

(30) Foreign Application Priority Data
May 8, 2009 (KR) 10-2009-0040157

(51) Int. Cl. B01J 7/00; F23C 13/00

(52) U.S. Cl. 422/198; 431/268

(57) ABSTRACT

A catalytic combustor which can prevent spark ignition pollution without increasing the pressure in the catalytic combustor through structural isolation between a chamber and an igniter, and a fuel reformer having the same are disclosed. A catalytic combustor may include a housing having a cylindrical chamber, a first opening disposed at one end part of the chamber, a second opening for discharging an exhaust in the chamber, and an auxiliary channel for connecting the chamber and the second opening. A catalyst may be disposed in the chamber. When the length direction of the chamber corresponds to a gravitational direction, an igniter may be disposed apart from a virtual extension volume of the chamber extending in the gravitational direction and positioned at a lower portion of the housing.

### CROSS-REFERENCE TO RELATED APPLICATIONS

This application claims priority to and the benefit of Korean Application No. 10-2009-0040157, filed on May 8, 2009, and entitled: Catalytic Combustor and Fuel Reformer Having the Same, the entire content of which is hereby incorporated by reference in its entirety.

### BACKGROUND

1. Field of the Invention

The present invention relates to a catalytic combustor of a back surface oxidation structure, and a fuel reformer having the catalytic combustor.

2. Description of the Related Technology

A combustor is a device that combusts a fuel to generate heat and high-temperature gas. The heat generated from the combustor may be used in a reforming reaction of a reformer, preheating of fuel or water, and the like. The combustor may be manufactured in a manner that combusts a fuel sprayed into a combustion chamber through direct flame ignition, which combusts a fuel through an oxidation catalyst, or the like. The device that combusts a fuel through an oxidation catalyst is a catalytic combustor.

The catalytic combustor has an igniter for igniting a fuel in an initial operation. Generally, the igniter is not disposed adjacent to a channel for supplying a fuel into a combustion chamber because otherwise a fire could be started in a fuel pipe or fuel tank through a channel when the fuel is ignited. Therefore, most catalytic combustors have a structure in which a fuel channel is disposed at one side of a combustion chamber, and an igniter is disposed at the other side opposite to the one side of the combustion chamber.

A housing of the catalytic combustor is mainly manufactured using a stainless steel having the desired properties of durability and thermal resistance. Therefore, exfoliated powder containing an iron component is produced on an inner wall of the housing under a high-temperature oxidation atmosphere.

When a channel for supplying fuel or air is disposed at a lower portion of the catalytic combustor in a gravitational direction, the exfoliated powder is accumulated at the lower portion of the combustion chamber. In this case, the exfoliated powder fills in the channel, so the pressure in the catalytic combustor increases, the power consumption of a balance of plant (BOP) increases and flashback and hot spots are easily generated. Such a catalytic combustor may have problems with low efficiency and/or a short lifetime.

### SUMMARY OF CERTAIN INVENTIVE ASPECTS

In one aspect, a catalytic combustor has a back surface oxidation structure, which may prevent spark ignition pollution without increasing the pressure in the catalytic combustor through structural isolation between a chamber and an igniter.

In another aspect a catalytic combustor includes a housing, a chamber disposed within the housing, the chamber having a top and a bottom, wherein a length of the chamber between the top and the bottom is greater than a width of the chamber and wherein the chamber is oriented within the housing such that the length is approximately aligned with respect to a gravitational direction, a first passage in fluid communication with both the housing and the top of the chamber, wherein the first passage is configured to receive fuel from outside the housing and pass the fuel into the top of the chamber, a catalyst disposed within the chamber, an auxiliary channel in fluid communication with the chamber and with a second passage in fluid communication with the housing, wherein the auxiliary channel is configured to receive exhaust from the chamber closer to the bottom of the chamber than the top of the chamber, and wherein the second passage is configured for discharging exhaust from the auxiliary channel and an igniter disposed in an angular orientation from the bottom of the chamber.

In some embodiments, the angular orientation includes an elbow-shaped ignition channel having a first end in fluid communication with the housing and a second end in fluid communication with the chamber, and wherein the first end at least partially houses the igniter. In some embodiments, the second end of the elbow-shaped ignition channel is in fluid communication with the cylindrical chamber closer to the bottom of the cylindrical chamber than the auxiliary channel. In some embodiments, the elbow-shaped ignition channel is bent at an angle between about 90 degrees and about 180 degrees. In some embodiments, the ignition channel has an irregular portion formed on an inner wall thereof. In some embodiments, the catalytic combustor further includes a magnet disposed on the elbow-shaped ignition channel. In some embodiments, the catalytic combustor further includes a magnet disposed within the elbow-shaped ignition channel. In some embodiments, the elbow-shaped ignition channel extends through the housing. In some embodiments, the elbow-shaped ignition channel includes an elbow pipe. In some embodiments, the chamber is a cylindrical chamber and the housing is formed from stainless steel.

In another aspect, a fuel reformer includes a catalytic combustor and a reforming reactor configured for reforming a fuel with heat supplied from the catalytic combustor to generate a reformate.

In some embodiments, the fuel reformer further includes an elbow-shaped ignition channel having a first end in fluid communication with the housing and a second end in fluid communication with the cylindrical chamber, wherein the first end is disposed apart from the virtual extension volume of the cylindrical chamber and wherein the first end at least partially houses the igniter. In some embodiments, the one end of the elbow-shaped ignition channel is in fluid communication with the cylindrical chamber closer to the bottom of the cylindrical chamber than the auxiliary channel. In some embodiments, the elbow-shaped ignition channel is bent at an angle between about 90 degrees and about 180 degrees. In some embodiments, the elbow-shaped ignition channel has a wrinkle portion formed at an inner wall thereof. In some embodiments, the fuel reformer further includes a magnet disposed within the elbow-shaped ignition channel. In some embodiments, the fuel reformer further includes a magnet disposed on the elbow-shaped ignition channel. In some embodiments, the elbow-shaped ignition channel extends through the housing in an elbow shape. In some embodiments, the elbow-shaped ignition channel includes an elbow pipe. In some embodiments, the chamber is a cylindrical chamber and the housing is formed from a stainless steel.

According to yet another aspect a fuel reformer includes a catalytic combustor according to any one of the embodiments described above, and a reforming reactor for reforming a fuel with heat supplied from the catalytic combustor to generate a reformate.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus according to some of the described embodiments can have several aspects, no single one of which necessarily is solely responsible for the desirable attributes of the apparatus. After considering this discussion, and particularly after reading the section entitled “Detailed Description of Certain Inventive Embodiments” one will understand how illustrated features serve to explain certain principles of the present disclosure.

FIG. 1A is a schematic perspective view of one embodiment of a catalytic combustor.

FIG. 1B is a cross-sectional view of the catalytic combustor of FIG. 1A.

FIG. 2 is a partial cross-sectional view of a principle part of one embodiment of a catalytic combustor.

FIGS. 3A and 3B are partial cross-sectional views illustrating other ignition channels of embodiments of a catalytic combustor.

FIG. 4 is a cross-sectional view of another embodiment of a catalytic combustor.

FIG. 5 is a perspective view illustrating an ignition channel applicable to the catalytic combustor of FIG. 4.

FIGS. 6A and 6B are partial cross-sectional views illustrating ignition channels applicable to embodiments of an ignition channel.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

Hereinafter, certain embodiments will be described in more detail with reference to the accompanying drawings, so that a person having ordinary skill in the art can readily make and use aspects of the present disclosure.

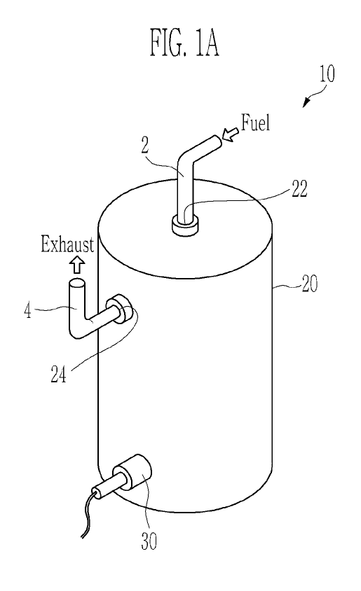

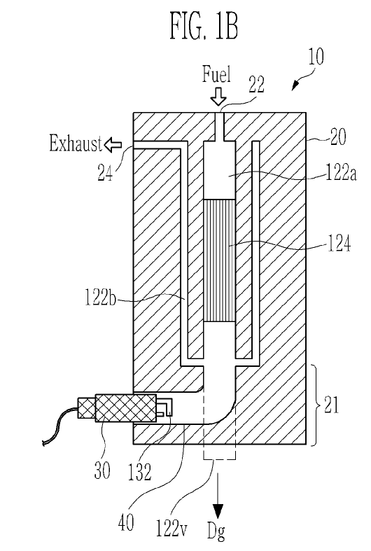

FIG. 1A is a schematic perspective view of a catalytic combustor according to one embodiment of the present disclosure. FIG. 1B is a schematic cross-sectional view of the catalytic combustor of FIG. 1A. Referring to FIGS. 1A and 1B, the catalytic combustor 10 includes a housing 20 having a chamber 122a, a catalyst 124 disposed in the chamber 122a, and an igniter 30 disposed at an extension of the chamber 122a.

The housing 20 may be formed in the shape of a cylinder with a predetermined first cross-sectional area and length. As illustrated in FIGS. 1A and 1B, both ends of the cylindrical housing 20 are substantially closed. The housing 20 has a first opening 22 through which a fuel and/or an oxidizer is flowed into the chamber 122a and a second opening 24 through which an exhaust is discharged from the chamber 122a. A first pipe 2 for supplying the fuel and/or oxidizer may be connected to the first opening 22 so that the fuel and/or oxidizer can pass through the first opening 22 from the first pipe 2. A second pipe 4 for receiving exhaust may be connected to the second opening 24 in the housing. The fuel may include, for example, a hydrocarbon fuel such as gasoline, liquefied petroleum gas (LPG) or liquefied natural gas (LNG).

The housing 20 may at least partially enclose the chamber 122a, which in the illustrated embodiments of FIGS. 1A and 1B has a cylindrical structure. When the length direction of the cylindrical chamber 122a corresponds to a gravitational direction, the first opening 22 is formed at an upper portion of the cylindrical chamber 122a where the cylindrical chamber 122a is in fluid communication with the first opening 22 extending through the housing 20.

The housing 20 may have an auxiliary channel 122b. The auxiliary channel 122b is in fluid communication both with a lower portion of the chamber 122a and with the second opening 24 so that a fluid may pass from the cylindrical chamber 122a through the second opening 24. Therefore, is the auxiliary channel 122b may be shaped such that fluid may flow through the auxiliary channel 122b in a direction opposite the fuel and/or oxidizer entering through the first opening 22 into the cylindrical chamber 122a. In some embodiments the auxiliary channel 122b has a U-shaped flow structure. In some embodiments the fluid in the auxiliary channel 122b within the housing 20 flows “backward” when compared with the fuel and/or oxidizer flowing into the cylindrical channel 122a.

The catalyst 124 may be formed of an active material coupled to a metallic honeycomb support or ceramic honeycomb support (carrier). The active material may include, for example, platinum (Pd), white gold (Pt) or other noble metal materials. For example, the catalyst 124 may include at least one selected from the group consisting of Pd, Pt, Co₃O₄, PdO, Cr₂O₃, Mn₂O₃, CuO, Fe₂O₃, V₂O₃, NiO, MoO₃ and TiO₂.

The igniter 30 includes a device for generating sparks. For example, the igniter 30 may include one of a high energy ignition system, a distributor ignition system, a distributorless ignition system. Also, the igniter 30 may include a contact point ignition system or an electronic ignition system. When the length direction of the cylindrical chamber 122a corresponds to a gravitational direction Dg, the igniter 30 is disposed apart from the lower portion of the chamber 122a and positioned at a lower portion of the housing 20. The igniter 30 in the illustrated embodiment is positioned apart from a virtual extension volume 122v of the chamber 122a, which virtual extension volume 122v extends in the gravitational direction from the chamber 122a. As illustrated in FIG. 1B the virtual extension volume Dg may include a volume of the chamber 122a to be formed if the chamber 122a were extended in the gravitational direction or the length direction of the chamber 122a. A terminal portion 132 of the igniter 30 may include, for example, a pair of electrodes for generating sparks by means of external electric power.

The catalytic combustor according to some embodiments of the present disclosure may include an ignition channel 40. As illustrated in FIG. 1B, the ignition channel 40 has one end in fluid communication with the lower portion of the chamber 122a, and the other end portion disposed apart from the virtual extension volume 122v of the chamber 122a and in fluid communication with the igniter 30.

In one embodiment, the ignition channel 40 may extend through a hole in a wall 21 formed at a lower portion of the housing 20. The ignition channel 40 may have an elbow shape bent at a predetermined angle as illustrated in FIG. 1B. One end portion of the ignition channel 40 is connected to the chamber 122a near one end of the auxiliary channel 122b and the other end of the ignition channel is in fluid communication with the igniter 30.

According to the embodiment of the catalytic combustor 10 described above, it is possible to prevent the terminal portion 132 of the igniter 30 from being covered with an exfoliated powder produced under a high-temperature atmosphere in the housing 20. Further, it is possible to prevent the terminal portion 132 of the igniter 30 from getting wet by moisture. When the catalytic combustor 10 is stopped, the moisture is formed in the housing 20 and accumulated at the lower portion of the cylindrical chamber 122a depending on environment in which the catalytic combustor 10 is installed. Accordingly, the ignition operation of the catalytic combustor 10 may be stabilized.

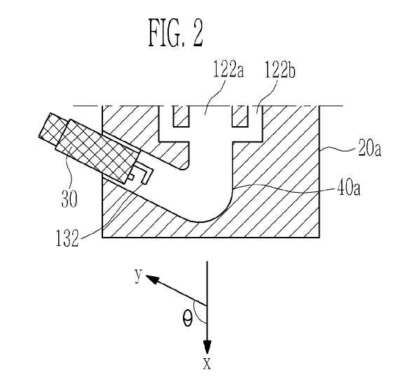

FIG. 2 is a partial cross-sectional view of a principle part in the catalytic combustor according to an embodiment of the present disclosure. Referring to FIG. 2, in an elbow-shaped ignition channel 40a applied to the catalytic combustor a first portion including one end portion of the ignition channel 40a may extend on a straight line in the length direction (illustrated in FIG. 2 as the “x direction”) parallel to the upper to lower portions of a housing 20a. A second portion of the ignition channel 40a may be bent at a first angle θ (an angle formed between the x direction and the direction of the second portion, the “y direction”). In other words, one end in the first portion of the ignition channel 40a is connected to the chamber 122a near the auxiliary channel 122b in a lower portion of the housing 20a. The other end of the second portion is connected to the igniter 30. As illustrated in FIG. 2, the terminal portion 132 of the igniter 30 is disposed away from the second portion of the ignition channel 40a.

In one embodiment, the range of the first angle θ may be between about 90 and about 180 degrees. If the elbow-shaped ignition channel 40a is formed at an angle smaller than 90 degrees, the terminal portion 132 of the igniter 30 may be covered with the exfoliated powder that falls from inner walls of the chamber 122a and the auxiliary channel 122b in the housing 20a. The terminal portion 132 of the igniter 30 may be partially or wholly submerged into water. Here, the water is formed in the chamber 122a and the auxiliary channel 122b and accumulated in the lower portion of the housing 20a, for example, the ignition channel 40a when the catalytic combustor is stopped.

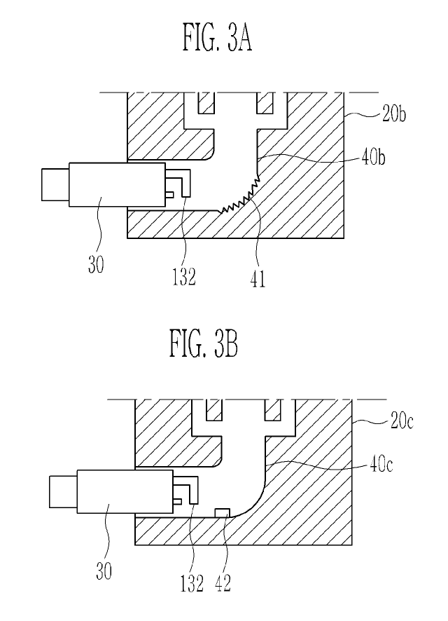

FIGS. 3A and 3B are partial cross-sectional views illustrating other ignition channels of the catalytic combustor according to embodiments of the present disclosure. Referring to FIG. 3A, an ignition channel 40b may have a wrinkle portion 41 formed in an interior thereof. When the ignition channel 40b is formed in the shape of a hole in at least one of walls defining a housing 20b, the wrinkle portion 41 includes an irregular portion formed at an inner wall of the hole. When the exfoliated powder falls into the ignition channel 40b, the wrinkle portion 41 allows the exfoliated powder not to move toward the igniter 30, thereby preventing the terminal portion 132 of the igniter 30 from being covered with the exfoliated powder.

Referring to FIG. 3B, an ignition channel 40c may include a magnet 42. The magnet 42 may be appropriately fixed to an inner wall of the ignition channel 40c formed in the shape of a hole in at least one of walls defining a housing 20c. The magnet 42 may include a permanent magnet. The magnet 42 may be configured to attract the exfoliated powder containing an iron (Fe) component. Accordingly, the magnet 42 may be disposed in the ignition channel 40c, thereby preventing the exfoliated powder from moving toward the igniter 30 or covering the terminal portion 132 of the igniter 30.

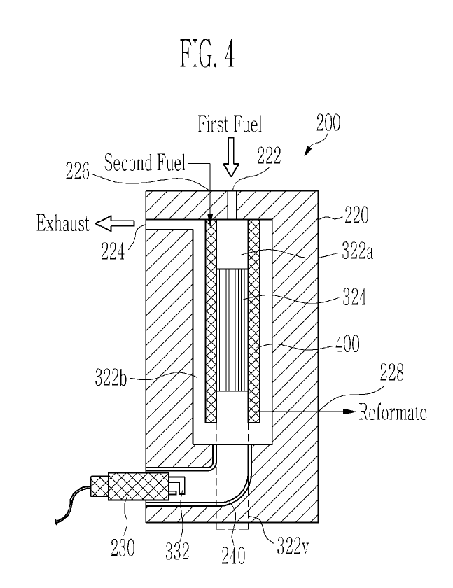

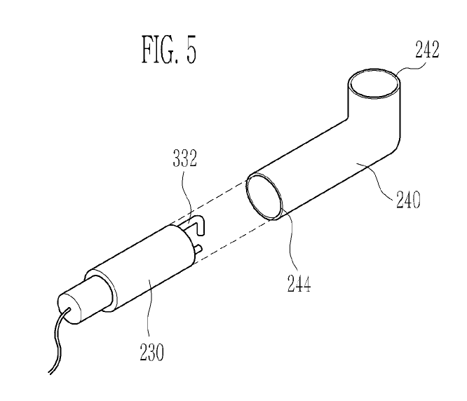

FIG. 4 is a cross-sectional view of a catalytic combustor according to an embodiment of the present disclosure. FIG. 5 is a perspective view illustrating an ignition channel applicable to the catalytic combustor of FIG. 4. Referring to FIG. 4, the catalytic combustor 200 includes a housing 220 having a cylindrical chamber 322a; a catalyst 324 disposed in the chamber 322a; an igniter 230 disposed apart from a side of the chamber 322a and in a side of the housing 220; and an ignition channel 240 for isolating an ignition portion from an oxidation portion of the chamber 322a so that the igniter 230 is disposed apart from a virtual extension volume 322v extending in a length direction of the cylindrical chamber 322a.

The housing 220 has a first opening 222 through which a first fuel is received into the chamber 322a and a second opening 224 through which an exhaust is discharged from the chamber 322a. The first fuel may include, for example, a hydrocarbon fuel such as gasoline, LPG or LNG.

The housing 220 may have a third opening 226 through which a second fuel is received into the reforming reactor 400 and a fourth opening 228 through which a reformate is discharged from the reforming reactor 400. In this case, the catalytic combustor 200 may be used as a device for supplying heat to the reforming reactor 400 coupled to the housing 220.

The housing 220 may have an auxiliary channel 322b. The auxiliary channel 322b allows the lower portion of the chamber 322a to be connected to the second opening 224 so that a fluid can pass to the second opening 224 from the chamber 322a. Therefore, the auxiliary chamber 322b has a counter flow or U-shaped flow structure in which a fluid in the housing 220 flows opposite the direction of flow into the first opening and into the chamber 322a. The catalyst 324 illustrated in FIG. 4 may correspond to the catalyst 124 in the catalytic combustor of FIG. 1B. The igniter 230 illustrated in FIG. 4 may correspond to the igniter 30 in the catalytic combustor of FIG. 1B.

Referring to FIGS. 4 and 5, the ignition channel 240 includes an elbow pipe. Here, the ignition channel 240 is appropriately installed at a lower portion of the housing 220. One end portion 242 of the ignition channel 240 is connected to the lower portion of the chamber 322a near the auxiliary channel 322b, and the other end portion 244 of the ignition channel 240 is connected to the igniter 230.

The bent angle of the ignition channel 240 has the same range as that of the first angle θ illustrated in FIG. 2. In the embodiment of FIG. 5, it is assumed that a straight tubular member having one end portion 242 and the other end portion 244 are positioned on a straight line. The bent angle may be defined as an angle formed when a middle portion of the one end portion 242 and the other end portion 244 are bent in the state that the one end portion 242 and the middle portion of the one end portion 244 are fixed on the straight line.

When using the ignition channel 240, it is possible to prevent the exfoliated powder that falls from an inner wall of the housing from covering a terminal portion 332 of the igniter 230. Further, it is possible to prevent the terminal portion 332 of the igniter 230 from being partially or wholly submerged into water accumulated at the lower portion of the housing 220 when the catalytic combustor 200 is stopped.

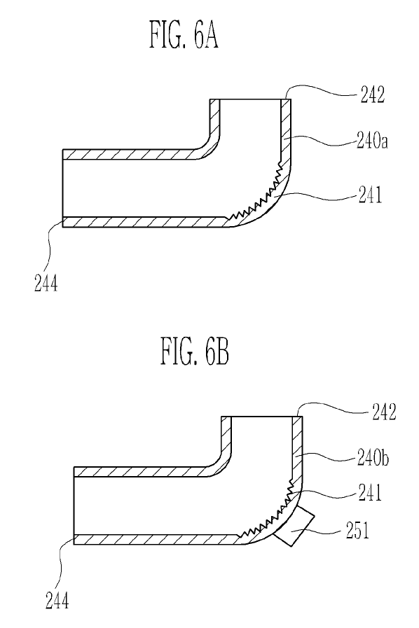

FIGS. 6A and 6B are partial cross-sectional views illustrating ignition channels analogous to the ignition channels described previously. Each of the ignition channels of FIGS. 6A and 6B may be used as the ignition channel in the catalytic combustor of FIG. 4.

Referring to FIG. 6A, an ignition channel 240a may have a wrinkle portion 241 formed in an interior thereof. The wrinkle portion 241 may include an irregular or saw-tooth portion formed at an inner wall of the ignition channel 240a. When the exfoliated powder falls into the ignition channel 240a, the wrinkle portion 241 allows the exfoliated powder not to move toward the igniter 230, thereby preventing the terminal portion 332 of the igniter 230 from being covered with the exfoliated powder.

Referring to FIG. 6B, an ignition channel 240b may further have a magnet 251 together with the wrinkle portion 241. The magnet 251 may be appropriately fixed to an outer wall of a separate elbow pipe forming the ignition channel 240b. The magnet 251 may include a permanent magnet. The magnet 251 may be configured to attract the exfoliated powder containing an iron (Fe) component. Accordingly, the magnet 251 is disposed in the ignition channel 240b, thereby preventing the exfoliated powder from approaching the igniter 230 or covering the terminal portion 332 of the igniter 230.

According to the aforementioned configuration, a fuel reformer having a catalytic combustor may be implemented. The reforming reactor 400 illustrated in FIG. 4 may include a steam reforming reactor for steam-reforming a hydrocarbon fuel to generate a reformate containing abundant hydrogen. Detailed descriptions for the structure and shape of the reforming reaction portion 400 will be omitted, as is obvious for those skilled in the art.

It will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Further, while the present disclosure has described certain exemplary embodiments, it is to be understood that the scope of the disclosure is not limited to the disclosed embodiments, but, on the contrary, is intended to cover various modifications and equivalent arrangements included within the spirit and scope of the appended claims and equivalents thereof.

What is claimed is:

1. A catalytic combustor, comprising:
a housing;
a chamber disposed within the housing, the chamber having a top and a bottom, wherein a length of the chamber between the top and the bottom is greater than a width of the chamber and wherein the chamber is oriented within the housing such that the length is approximately aligned with respect to a gravitational direction;
a first passage in fluid communication with both the housing and the top of the chamber, wherein the first passage is configured to receive fuel from outside the housing and pass the fuel into the top of the chamber;
a catalyst disposed within the chamber;
an auxiliary channel in fluid communication with the chamber and with a second passage in fluid communication with the housing, wherein the auxiliary channel is configured to receive exhaust from the chamber closer to the bottom of the chamber than the top of the chamber, and wherein the second passage is configured for discharging exhaust from the auxiliary channel; and
an igniter disposed in an angular orientation from the bottom of the chamber.

2. The catalytic combustor according to claim 1, wherein the angular orientation comprises an elbow-shaped ignition channel having a first end in fluid communication with the housing and a second end in fluid communication with the chamber, and wherein the first end at least partially houses the igniter.

3. The catalytic combustor according to claim 2, wherein the second end of the elbow-shaped ignition channel is in fluid communication with the cylindrical chamber closer to the bottom of the cylindrical chamber than the auxiliary channel.

4. The catalytic combustor according to claim 2, wherein the elbow-shaped ignition channel is bent at an angle between about 90 degrees and about 180 degrees.

5. The catalytic combustor according to claim 2, wherein the ignition channel has an irregular portion formed on an inner wall thereof.

6. The catalytic combustor according to claim 5 further comprising a magnet disposed on the elbow-shaped ignition channel.

7. The catalytic combustor according to claim 2 further comprising a magnet disposed within the elbow-shaped ignition channel.

8. The catalytic combustor according to claim 2, wherein the elbow-shaped ignition channel extends through the housing.

9. The catalytic combustor according to claim 2, wherein the elbow-shaped ignition channel includes an elbow pipe.

10. The catalytic combustor according to claim 1, wherein the chamber is a cylindrical chamber and wherein the housing is formed from stainless steel.

11. A fuel reformer comprising:
the catalytic combustor of claim 1; and
a reforming reactor configured for reforming a fuel with heat supplied from the catalytic combustor to generate a reformate.

12. The fuel reformer according to claim 11 further comprising an elbow-shaped ignition channel having a first end in fluid communication with the housing and a second end in fluid communication with the cylindrical chamber, wherein the first end is disposed apart from the virtual extension volume of the cylindrical chamber and wherein the first end at least partially houses the igniter.

13. The fuel reformer according to claim 12, wherein the one end of the elbow-shaped ignition channel is in fluid communication with the cylindrical chamber closer to the bottom of the cylindrical chamber than the auxiliary channel.

14. The fuel reformer according to claim 12, wherein the elbow-shaped ignition channel is bent at an angle between about 90 degrees and about 180 degrees.

15. The fuel reformer according to claim 12, wherein the elbow-shaped ignition channel has a wrinkle portion formed at an inner wall thereof.

16. The fuel reformer according to claim 15 further comprising a magnet disposed within the elbow-shaped ignition channel.

17. The fuel reformer according to claim 12 further comprising a magnet disposed on the elbow-shaped ignition channel.

18. The fuel reformer according to claim 12, wherein the elbow-shaped ignition channel extends through the housing in an elbow shape.

19. The fuel reformer according to claim 12, wherein the elbow-shaped ignition channel includes an elbow pipe.

20. The fuel reformer according to claim 11, wherein the chamber is a cylindrical chamber and wherein the housing is formed from a stainless steel.
